(19) United States
(12) Patent Application Publication
(10) Pub. No.: US 2009/0033241 A1
(43) Pub. Date: Feb. 5, 2009

(54) Light emitting diode module and driving apparatus

(75) Inventor: Jiann-Gwo Yu, Taipei (TW)

Correspondence Address: BACON & THOMAS, PLLC, 625 SLATERS LANE, FOURTH FLOOR, ALEXANDRIA, VA, 22314-1176, US

(73) Assignee: LITE-ON TECHNOLOGY CORPORATION, Taipei (TW)

(21) Appl. No.: 12/071,947

(22) Filed: Feb. 28, 2008

(30) Foreign Application Priority Data
Aug. 1, 2007 (TW) 96128305

(51) Int. Cl. H05B 41/16

(52) U.S. Cl. 315/277

(57) ABSTRACT

A driving apparatus for driving a light emitting diode (LED) unit with a positive and a negative driving ends is provided. The driving apparatus includes first, second, and third rectifying units for driving the LED unit to illuminate respectively in response to the first, the second, and the third phase signals of an input signal. The first, the second, and the third rectifying units have the same circuit structure. Let the first rectifying unit be taken for example. The first rectifying unit includes first and second high breakdown-voltage diodes. The P end of the first high breakdown-voltage diode and the N end of the second high breakdown-voltage diode are connected for receiving the first phase signal; the N end of the first high breakdown-voltage diode and the P end of the second high breakdown-voltage diode are respectively connected to the negative and the positive driving ends.

This application claims the benefit of Taiwan application Serial No. 96128305, filed Aug. 1, 2007, the subject matter of which is incorporated herein by reference.

### BACKGROUND OF THE INVENTION

1. Field of the Invention

The invention relates in general to a light emitting diode (LED) module, and more particularly to an LED module which rectifies by means of a specific high breakdown-voltage diode.

2. Description of the Related Art

With the advance in science and technology, light emitting diode (LED), due to the advantages of long lifespan and low power consumption, has been widely used in various purposes of illumination. As the LED has the characteristics of one-way conduction, the LED driving apparatus is normally equipped with a rectifier so that the LED can be driven by a direct current electrical signal. However, how to develop an LED module whose cost and size are reduced but fields of application are increased and a driving apparatus thereof has always been an imminent target to achieve.

### SUMMARY OF THE INVENTION

The invention is directed to a driving apparatus and a light emitting diode (LED) module, which uses fewer elements, has smaller circuit size, and incurs lower cost in comparison with the conventional LED driving apparatus. The provided driving apparatus and the LED module can be a three-phase circuit, which works according to a three-phase supply.

According to a first aspect of the present invention, a driving apparatus for driving light emitting diode (LED) unit in response to an input signal is provided. The LED unit has a first driving end and a second driving end. The driving apparatus includes a first rectifying unit and a second rectifying unit for driving the LED unit respectively in response to the first phase signal and the second phase signal of an input signal. The first rectifying unit includes a first high breakdown-voltage diode and a second high breakdown-voltage diode. The P end of the first high breakdown-voltage diode and the N end of the second high breakdown-voltage diode are mutually connected for receiving the first phase signal; the N end of the first high breakdown-voltage diode and the P end of the second high breakdown-voltage diode are respectively connected to the first driving end and the second driving end. The second rectifying unit includes a third high breakdown-voltage diode and fourth high breakdown-voltage diode. The P end of the third high breakdown-voltage diode and the N end of the fourth high breakdown-voltage diode are mutually connected for receiving the second phase signal; the N end and of the third high breakdown-voltage diode and the P end of the fourth high breakdown-voltage diode are respectively connected to the first driving end and the second driving end.

According to a second aspect of the present invention, an LED module for illuminating in response to an input signal is provided. The LED module includes an LED unit and a driving apparatus. The LED unit includes a first driving end and a second driving end. The driving apparatus drives the LED unit to illuminate in response to the input signal. The driving apparatus including a first rectifying unit and second rectifying unit drives the LED unit to illuminate respectively in response to the first phase signal and the second phase signal of the input signal. The first rectifying unit includes a first high breakdown-voltage diode and a second high breakdown-voltage diode. The P end of the first high breakdown-voltage diode and the N end of the second high breakdown-voltage diode are mutually connected for receiving the first phase signal; the N end of the first high breakdown-voltage diode and the P end of the second high breakdown-voltage diode are respectively connected to the first driving end and the second driving end. The second rectifying unit includes a third high breakdown-voltage diode and a fourth high breakdown-voltage diode. The P end of the third high breakdown-voltage diode and the N end of the fourth high breakdown-voltage diode are mutually connected for receiving the second phase signal; the N end of the third high breakdown-voltage diode and the P end of the fourth high breakdown-voltage diode are respectively connected to the first driving end and the second driving end.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of an LED module according to a first embodiment of the invention;

FIG. 2 is a wave pattern of the voltage phase signals Si1 and Si2 of FIG. 1;

FIG. 3 is a characteristics curve of the high breakdown-voltage diodes T1˜T4 of FIG. 1;

FIG. 4 is a block diagram of an LED module according to a second embodiment of the invention; and

FIG. 5 is a wave pattern of the voltage phase signals S1˜S3 of FIG. 4.

### DETAILED DESCRIPTION OF THE INVENTION

The driving apparatus of the present embodiment of the invention is equipped with many rectifying units having high breakdown-voltage diodes for rectifying alternate current signals according to the characteristics of the high breakdown-voltage diode and accordingly driving the light emitting diode (LED) unit.

### First Embodiment

Referring to FIG. 1, a block diagram of an LED module according to a first embodiment of the invention is shown. The LED module 10 illuminates in response to a voltage input signal. The LED module 10 includes a light emitting diode (LED) unit 12 and a driving apparatus 14. The LED unit 12 includes many LEDs 120 connected in serial and/or parallel. In the present embodiment of the invention, the LED unit 12 includes driving ends E1 and E2 and the LEDs 120 are serially connected between the driving ends E1 and E2. The driving end E1 is, for example, the positive driving end of the LED unit 12. The driving end E2 is, for example, the negative driving end of the LED unit 12.

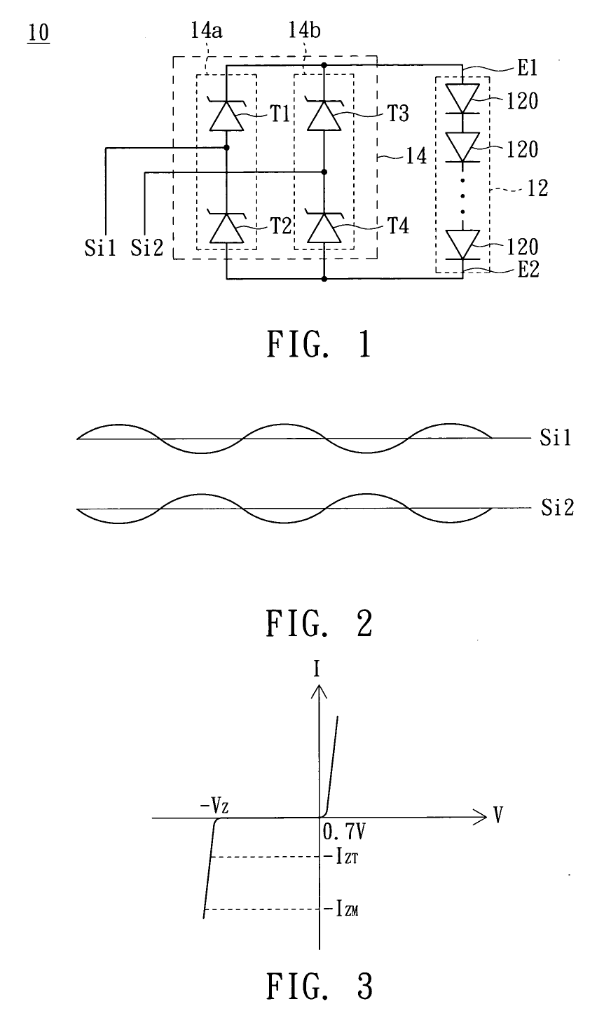

The driving apparatus 14 includes rectifying units 14a and 14b for receiving and rectifying a voltage input signal to provide a forward-rectified voltage to the driving end E1 for driving each LED 120 of the LED unit 12 to illuminate. In the present embodiment of the invention, the voltage input signal includes two voltage phase signals Si1 and Si2 whose peak-to-peak voltages are substantially the same. The phase of the voltage phase signal Si1 leads that of the voltage phase signal Si2 by 180 degrees and the wave pattern of the voltage phase signal is illustrated in FIG. 2.

The rectifying unit 14a includes high breakdown-voltage diodes T1 and T2. The P end of the high breakdown-voltage diode T1 and the N end of the high breakdown-voltage diode t2 are mutually connected for receiving the voltage phase signal Si1. The N end of the high breakdown-voltage diode T1 and the P end of the high breakdown-voltage diode T2 are respectively connected to the driving end E1 and the driving end E2. The rectifying unit 14b includes two high breakdown-voltage diodes T3 and T4, wherein the P end of the high breakdown-voltage diode T3 and the N end of the high breakdown-voltage diode T4 are mutually connected for receiving the voltage phase signal Si2, and the N end of the high breakdown-voltage diode T3 and the P end of the high breakdown-voltage diode T4 are respectively connected to the driving end El and the driving end E2.

When the voltage phase signals Si1 and Si2 are respectively at a positive half-cycle and a negative half-cycle, the high breakdown-voltage diode T1 and T4 are turned on, so as to provide a forward biased voltage between the driving ends E1 and E2 for driving the LED unit 12 to illuminate. Meanwhile, the high breakdown-voltage diodes T2 and T3 are turned off. When the voltage phase signals Si1 and Si2 are respectively at a negative semi-cycle and a positive semi-cycle, the high breakdown-voltage diode T2 and T3 are turned on, so as to provide a forward biased voltage between the driving ends E1 and E2 for driving the LED unit 12 to illuminate. Meanwhile, the high breakdown-voltage diode T1 and T4 are turned off.

Wherein, the inverse biased breakdown-voltages of the high breakdown-voltage diodes T1˜T4 are higher than the peak-to-peak voltages of the voltage phase signals Si1 and Si2 lest the high breakdown-voltage diodes T1˜T4 might breakdown. Thus, the LED module 10 of the present embodiment of the invention can effectively rectify the voltage input signal through the driving apparatus 14 having four high breakdown-voltage diodes T1˜T4 and accordingly drive the LED unit 12 to illuminate.

In the present embodiment of the invention, the high breakdown-voltage diodes T1˜T4 are high breakdown-voltage GaN Schottky barrier diodes which increase the inverse biased breakdown-voltage by specific gate field-plate structure, and the characteristics curve of the of the high breakdown-voltage diodes T1˜T4 is illustrated in FIG. 3. In the present embodiment of the invention, the inverse biased breakdown-voltage −Vz of the high breakdown-voltage GaN Schottky barrier diode is substantially close to −1000V. Thus, when the peak-to-peak voltages of the voltage phase signals Vi1 and Vi2 are smaller than 1000V, the driving apparatus 14 of the present embodiment of the invention can effectively rectify and drive the LED unit 12 to illuminate.

In the present embodiment of the invention, as the breakdown-voltage of the high breakdown-voltage diodes T1˜T4 is close to 1000V, the high breakdown-voltage diodes T1˜T4 can individually withstand the inverse biased voltage at the two ends without using additional voltage reduction mechanism such as serial connected diodes having lower breakdown-voltages. Thus, the driving apparatus 14 of the present embodiment of the invention has the advantages of using lesser elements on the rectifying units 14a and 14b, occupying smaller manufacturing area and incurring lower manufacturing cost.

In the present embodiment of the invention, the breakdown-voltages of the high breakdown-voltage diodes D1˜D4 is exemplified by high breakdown-voltage GaN Schottky barrier diodes whose high breakdown-voltage are substantially close to 1000V. However, the high breakdown-voltage diodes of the present embodiment of the invention are not limited to high breakdown-voltage GaN Schottky barrier diodes, other diodes having high breakdown-voltages such as other variety of Schottky barrier diodes or Zener diodes would also do. The breakdown-voltage of the high breakdown-voltage diode of the present embodiment of the invention does not necessarily be close to 1000V, and the high breakdown-voltage diode of the present embodiment of the invention can be determined according to the peak-to-peak voltage of the voltage input signal of the corresponding high breakdown-voltage diode.

In the present embodiment of the invention, the LED unit 12 includes many LEDs 120 which are connected in serial. However, the LEDs 120 of the LED unit 12 of the present embodiment of the invention do not necessarily be connected in serial. The LEDs 120 can be connected in serial and/or in parallel or any other possible circuit structures as long as the LEDs 120 in the LED unit 12 can be ignited by the voltage across the driving ends E1 and E2.

In the present embodiment of the invention, the rectifying units disposed in the LED module and the driving apparatus have two high breakdown-voltage diodes for rectifying an alternate current signal according to the characteristics of the high breakdown-voltage diode and accordingly driving the LED unit. Thus, the driving apparatus and the light emitting diode (LED) module disclosed in the embodiment uses fewer elements, has smaller circuit size, and incurs lower cost, in comparison with the conventional LED driving apparatus.

### Second Embodiment

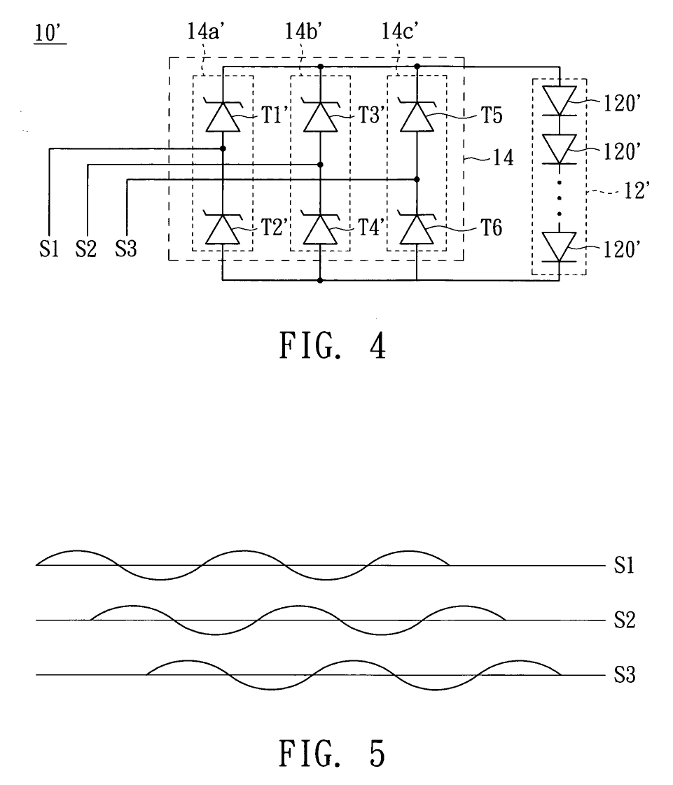

Referring to FIG. 4, a block diagram of an LED module according to a second embodiment of the invention is shown. The LED module 10′ of the present embodiment of the invention differs with the LED module 10 of the first embodiment in that the voltage input signal received by the LED module 10′ is a three-phase voltage input signal having three voltage phase signals S1, S2 and S3 whose wave pattern is illustrated in FIG. 5. As indicated in FIG. 5, the phase of the signal S2 and the phase of the signal S3 are respectively behind the phase of the signal S1 by (⅔)π and ( 4/3)π.

The LED module 10′ of the present embodiment of the invention includes three rectifying units 14a′, 14b′ and 14c, which perform substantially the same operation as the rectifying unit in the first embodiment, for respectively receiving and rectifying the voltage phase signals S1˜S3 to generate a positive voltage for driving the LED unit 12′. Thus, the LED module of the present embodiment of the invention advantageously uses lesser elements, has smaller circuit size and incurs lower manufacturing cost in comparison with the conventional LED driving apparatus.

Besides, the driving apparatus and the LED module of the embodiment includes three rectifying units for respectively receiving and rectifying the three voltage phase signals to generate a positive voltage driving the LED unit. Thus, the LED module of the present embodiment of the invention can be used in a three-phase electrical signal environment

Compared with the case when the voltage input signal is a dual-phase voltage input signal, the phase difference between any two phase signals is smaller if the voltage input signal is a three-phase voltage input signal, and the voltage provided to the LED module has a smaller level change. As a result, the LED module of the present embodiment of the invention further has the advantage of being driven by a more stable driving voltage.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving apparatus used for driving a light emitting diode (LED) unit in response to an input signal, wherein the LED unit comprises a first driving end and a second driving end, and the driving apparatus comprises:
a first rectifying unit used for driving the LED unit in response to a first phase signal of the input signal, wherein the first rectifying unit comprises a first high breakdown-voltage diode and a second high breakdown-voltage diode, the P end of the first high breakdown-voltage diode and the N end of the second high breakdown-voltage diode are mutually connected for receiving the first phase signal, and the N end of the first high breakdown-voltage diode and the P end of the second high breakdown-voltage diode are respectively connected to the first driving end and the second driving end; and
a second rectifying unit used for driving the LED unit in response to a second phase signal of the input signal, wherein the second rectifying unit comprises a third high breakdown-voltage diode and a fourth high breakdown-voltage diode, the P end of the third high breakdown-voltage diode and the N end of the fourth high breakdown-voltage diode are mutually connected for receiving the second phase signal, and the N end of the third high breakdown-voltage diode and the P end of the fourth high breakdown-voltage diode are respectively connected to the first driving end and the second driving end.

2. The driving apparatus according to claim 1, wherein the input signal is a dual-phase input signal and the phase difference between the first phase signal and the second phase signal is 180 degrees.

3. The driving apparatus according to claim 1, further comprising:
a third rectifying unit used for driving the LED unit in response to a third phase signal of the input signal, wherein the third rectifying unit comprises a fifth high breakdown-voltage diode and a sixth high breakdown-voltage diode, the P end of the fifth high breakdown-voltage diode and the N end of the sixth high breakdown-voltage diode are mutually connected for receiving the third phase signal, and the N end of the fifth high breakdown-voltage diode and the P end of the sixth high breakdown-voltage diode are respectively connected to the first driving end and the second driving end.

4. The driving apparatus according to claim 3, wherein the input signal is a triple-phase input signal, the phase of the first phase signal leads the phase of the second and the phase of the third phase signal by 120 degrees and 240 degrees respectively.

5. The driving apparatus according to claim 1, wherein the inverse biased breakdown withstand voltages of the first to the fourth high breakdown-voltage diodes are substantially greater than the max cross-voltage of any two phase signals of the input signal.

6. The driving apparatus according to claim 5, wherein the first to the fourth high breakdown-voltage diodes are Schottky barrier diodes.

7. The driving apparatus according to claim 5, wherein the first to the fourth high breakdown-voltage diodes are high breakdown-voltage GaN Schottky barrier diodes.

8. The driving apparatus according to claim 5, wherein the first to the fourth high breakdown-voltage diodes are Zener diodes.

9. A light emitting diode (LED) module used for illuminating in response to an input signal, wherein the LED module comprises:
an LED unit comprising a first driving end and a second driving end; and
a driving apparatus used for driving the LED unit in response to the input signal, wherein the driving apparatus comprises:
a first rectifying unit used for driving the LED unit in response to a first phase signal of the input signal, wherein the first rectifying unit comprises a first high breakdown-voltage diode and a second high breakdown-voltage diode, the P end of the first high breakdown-voltage diode and the N end of the second high breakdown-voltage diode are mutually connected for receiving the first phase signal, the N end of the first high breakdown-voltage diode and the P end and the second high breakdown-voltage diode are respectively connected to the first driving end and the second driving end; and
a second rectifying unit used for driving the LED unit in response to a second phase signal of the input signal, wherein the second rectifying unit comprises a third high breakdown-voltage diode and a fourth high breakdown-voltage diode, the P end of the third high breakdown-voltage diode and the N end of the fourth high breakdown-voltage diode are mutually connected for receiving the second phase signal, the N end of the third high breakdown-voltage diode and the P end of the fourth high breakdown-voltage diode are respectively connected to the first driving end and the second driving end.

10. The LED module according to claim 9, wherein the input signal is a dual-phase input signal and the phase difference between the first phase signal and the second phase signal is 180 degrees.

11. The LED module according to claim 9, wherein the driving apparatus further comprises:
a third rectifying unit used for driving the LED unit in response to a third phase signal of the input signal, wherein the third rectifying unit comprises a fifth high breakdown-voltage diode and a sixth high breakdown-voltage diode, the P end of the fifth high breakdown-voltage diode and the N end of the sixth high breakdown-voltage diode are mutually connected for receiving the third phase signal, the N end of the fifth high breakdown-voltage diode and the P end of the sixth high breakdown-voltage diode are respectively connected to the first driving end and the second driving end.

12. The LED module according to claim 11, wherein the input signal is a triple-phase input signal, the phase of the first phase signal leads the phase of the second and the phase of the third phase signal by 120 degrees and 240 degrees respectively.

13. The LED module according to claim 9, wherein the inverse biased breakdown withstand voltages of the first to the fourth high breakdown-voltage diodes are substantially greater than the max cross-voltage of any two phase signals of the input signal.

14. The LED module according to claim 13, wherein the first to the fourth high breakdown-voltage diodes are Schottky barrier diodes.

15. The LED module according to claim 13, wherein the first to the fourth high breakdown-voltage diodes are high breakdown-voltage GaN Schottky barrier diodes.

16. The LED module according to claim 13, wherein the first to the fourth high breakdown-voltage diodes are Zener diodes.
